(19) United States
(12) Patent Application Publication
(10) Pub. No.: US 2002/0074076 A1
(43) Pub. Date: Jun. 20, 2002

(54) Patch system kit and method for repairing a surface break in selected surfaces of a transparent object

(76) Inventors: Gerald Jacino, Kew Gardens, NY (US); Anthony Jacino, East Moriches, NY (US)

Correspondence Address: M. Arthur Auslander, Esq., Auslander & Thomas, 505 Eighth Avenue, New York, NY, 10018-6505, US

(21) Appl. No.: 09/927,890

(22) Filed: Aug. 10, 2001

Related U.S. Application Data
(60) Provisional application No. 60/225,039, filed on Aug. 12, 2000.

(51) Int. Cl. B32B 31/00

(52) U.S. Cl. 156/94; 156/349

(57) ABSTRACT

A patch system repairs breaks in lenses and housing.

### BACKGROUND OF THE INVENTION

The present invention relates to a patch system kit and method for repairing in situ a surface break in selected surfaces of an transparent object particularly an automobile lense or lightbulb housing.

Automobile light bulbs are oftentimes engaged in complex, expensive, enclosed housings protected by light bulb housings and lenses. The automobile bulb housings and lenses serve as light diffuser and protect the bulb from the atmosphere.

A break in a lens or housing must be repaired or there is the expense of replacing them. Effective repair of a lens or automobile light bulb housing having a light diffuser has been difficult.

Breaks have been difficult to access because of the shape of the break or the housing. The broken area may be colored and it may be difficult to restore the diffusive characteristics of the repaired area.

Oftentimes the only way to effect a repair includes to need to physically remove the lens or automobile light bulb housing. Another problem to be solved in the repair of automobile light bulb housings lens is the need to maintain the light diffusing characteristics of the lens once repaired. Repair of lenses in the past had many similarities to the repair of breaks through glass or plastic.

### DESCRIPTION OF THE RELATED ART

In the past, automobile light bulb housings and plastic lenses have been repaired by covering the housings with tape just to protect them from the atmosphere.

The tape has been either opaque or translucent. Tapes used in such repair have even been selected to match the color of the broken part of the lens. To repair voids, repairs have been made by the flush filling of the broken spaces; plastic castings were also made to fill breaks. Many different techniques were used. U.S. Pat. No. 4,497,755 discloses a kit for the repair of automobile light bulb housing lenses by casting the repair. The repair method includes the use of flush tapes to form a releasable form for molding an exothermic adhesive resin to make a repair. Colored resin was used to match colors in the automobile plastic light bulb housing and glass bead were used to simulate the facets in the broken diffuse area.

As shown in U.S. Pat. No. 5,401,152, breaks through glass have been repaired by providing a gasket with a cover to form a mold for a casting including a bead surrounding a repaired area. The gasket and cover define the shape of the repair casting.

U.S. Pat. No. 4,200,478 discloses a pedestal adapted to create a casting to override and surround a break in glass.

U.S. Pat. No. 3,887,413 discloses a method for repairing plastic materials, using an insert backing material, protective paste and graining paper and uses a hot surface, such as iron.

U.S. Pat. No. 3,772,114 discloses a process for mending fabrics, including the use of an adhesive which contains a color additive to match the area around the repair. The invention is involved with fitting in a flush patch supported on one side.

U.S. Pat. No. 3,388,016 discloses a method and apparatus for patching articles. The method and apparatus are a complex set to apply a fiber glass patch to one surface. Flush liners may be used.

U.S. Pat. No. 3,109,765 discloses a method for repairing surfaces, wherein a textured backing is used. A textured backing hold holds a composition applied from an outer surface of a rupture.

U.S. Pat. No. 4,961,883 discloses a pedestal and a seal surrounding an opening and forming a chamber for the introduction of a repair plastic forming an irregular bead, which has to be cut off flush. The bead is formed in the central opening 20.

U.S. Pat. No. 4,473,419 discloses the use of a flush patch to a contoured surface for the purpose of making a repair.

U.S. Pat. No. 3,138,505 discloses means for mending fabric, using a heat responsive thermoplastic adhesive backed by a substrate which may be stripped, then bonding a matching patch to the fabric and the adhesive. The patch is ironed on.

U.S. Pat. No. 3,841,932 discloses a surface patch for windshield glass, which leaves a superficial dam which is removed.

U.S. Pat. No. 3,914,145 discloses a flush patch casting for the repair of plate glass.

U.S. Pat. No. 4,147,576 is a substantially invisible non transparent auto body repair over a damaged area.

U.S. Pat. No. 4,094,316 is a decorative applique overlay adherable to bandage.

U.S. Pat. No. 4,588,619 is a reflective panel for diffusion of light in an automotive lens housing.

U.S. Pat. No. 4,221,465 is a patching tape to alter the light transmissive characteristics of a viewgraph.

U.S. Pat. No. 4,661,182 is a non transparent substantially invisible surface repair of a damaged glossy surface of an auto body.

U.S. Pat. No. 2,8338,327 is a laminated tire patch with an adhesive layer.

U.S. Pat. No. 3,939,337 is an elastomeric gasket for a light housing assembly for mounting a lens.

### SUMMARY OF THE INVENTION

According to the present invention, a kit and method are provided for repairing a break in the lens or housing in situ for an automobile light bulb. The kit and method are an inexpensive and labor saving simplification of the prior art complex systems of plastic castings employing gaskets and/or molds or using tapes or overlays.

The problems solved by the present invention are to provide a simple, inexpensive repair to an automobile light bulb housing or lens without having to replace the housing. The repairing of the automobile light bulb housing or lens is in situ, maintaining substantially the same light diffusion characteristics of the original lens or housing and maintaining the integrity of the repaired housing with a bulb inside.

### BRIEF DESCRIPTION OF THE DRAWING

Although such novel feature or features believed to be characteristic of the invention are pointed out in the claims, the invention and the manner in which it may be carried out may be further understood by reference to the description following and the accompanying drawings.

FIG. 1 is an elevation of a repair panel of the present invention.

FIG. 2 is a cut away enlarged right side detail view of FIG. 1.

FIG. 3 is a view of a selection of adhesive gasket strips of the present invention.

FIG. 4 is a cut away enlarged detail right side detail of an adhesive strip of FIG. 3.

FIG. 5 shows measuring the repair panel of FIG. 1 over a broken housing lens of an automobile.

FIG. 6 shows a detail of cutting out the measured panel of FIG. 5 to a size selected to overlap the broken lens.

FIG. 7 shows the cut panel of FIG. 6 with adhesive strips of FIG. 3 adhered at its periphery.

FIG. 8 shows the outer release paper of the adhesive strips being removed to prepare the repair panel for engagement over a selected break in a lens.

FIG. 9 shows repair panel being engaged over a break in a curved lens.

FIG. 10 shows another selected repair panel of the present invention.

FIG. 11 shows another selected repair panel of the present invention.

FIG. 12 shows a detail side view of the repair panel of FIG. 11 including an adhesive layer and release paper.

### DESCRIPTION OF THE FIGURES

Referring now to the figures in greater detail, where like reference numbers denote like parts in the various figures.

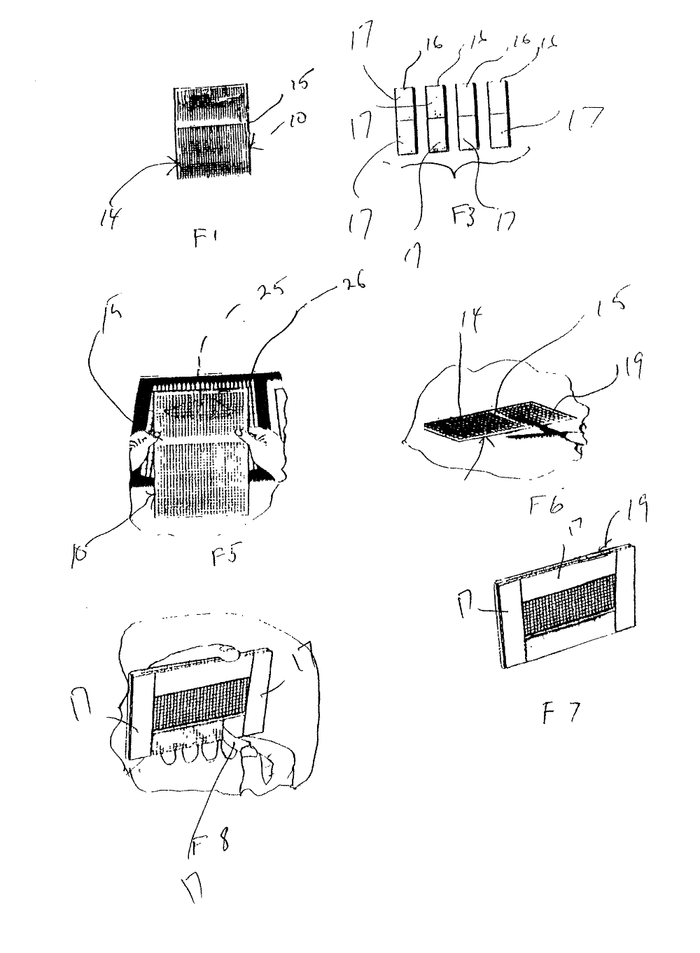

As shown in FIG. 1, the patch system kit includes a repair panel 10. As shown in FIG. 2 in enlarged detail, the repair panel 10 has an inner surface 11 and an outer surface 12. The inner surface 11 is flat with ridges 13 protruding outward in lines forming a grid 14. As shown in FIG. 1 the grid 14 is separated into two parts by a border 15

As shown in FIG. 3, gasket strips 16 are provided. The gasket strips 16, as shown in FIG. 4 include release papers 17, over adhesive layers 18.

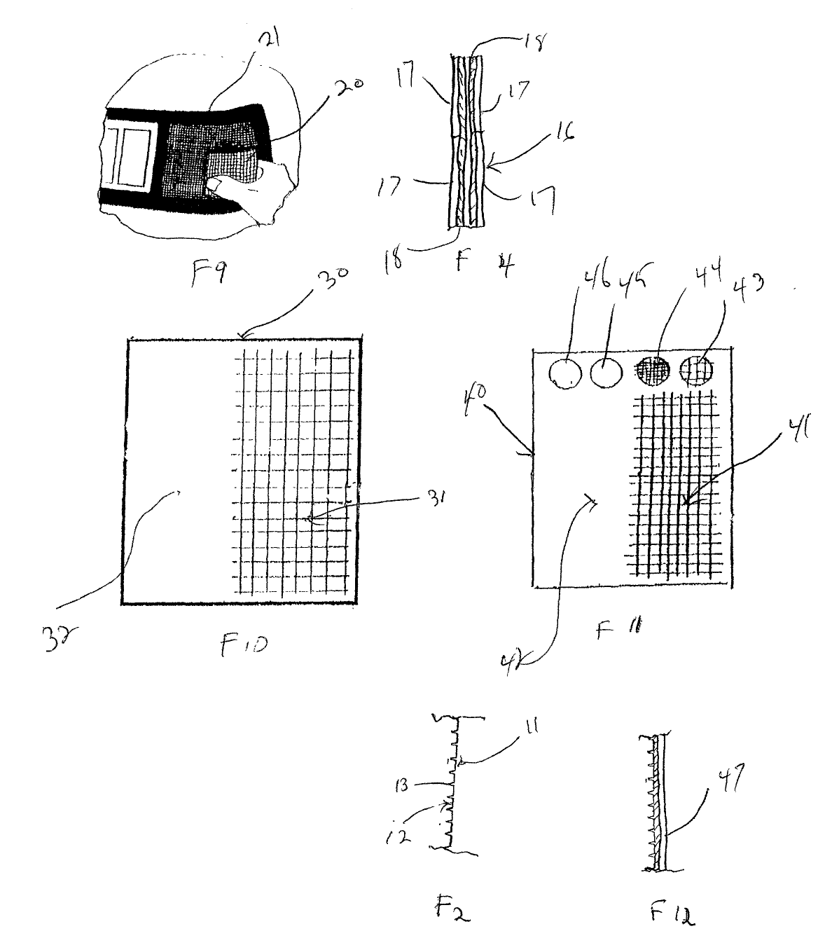

As shown in FIG. 5, the repair panel 10 is held over the damaged area 25 of a lens 26. As shown in FIG. 6, the repair panel 10 is cut at the border 15 forming a cut panel 19. As shown in FIG. 7 the gasket strips 16 are adhered to the panel 19. As shown in FIG. 8, the outer release papers 17 are removed from the panel 19.

FIG. 9 shows a cut panel 19 being engaged over a curved lens 21. FIG. 10 shows a repair panel 30 with a grid 31 and a clear portion 32.

FIG. 11 shows a repair panel 40 with grid 41, a clear portion 42, and a selection of round cuts, 43-46. FIG. 12 shows the release paper 47 over an adhesive layer 48 on the back of repair panel 40.

### OPERATION

In performing a repair, a repair panel 10 is held over a break in a lens or housing as shown in FIG. 5. The panel is cut to overlap the entire damaged area. Where a damaged area is small it may be convenient to cut the repair panel 10 at the border 15 as shown in FIG. 6. The gasket strips 16 are then selected to form a secure atmosphere safe repair.

A release paper 17 is removed from one side of a gasket strips 16. The gasket strips 16 is applied to the inner surface 11 of the cut panel 19 forming a border as shown in FIG. 7. The release papers 17, as shown in FIG. 8, are removed from the adhesive layers 18 so they can be engaged over the damaged area to effect a complete repair.

As shown in FIG. 9, the cut panel 19 with the release paper 27 removed, as shown in FIG. 8, is engaged over a break 50 in the curved lens 21. The flexibility of the cut panel 19 enables a liquid type seal effecting the perfect repair.

The repair panels 30 and 40, with the adhesive layer 48 on the back of each available, to be cut and molded over cracks, breaks in lenses, such as lenses 21 and 26. The selected configuration of color and ridges for the deflection of light is selected and engaged over the break in a flat, or curved surface.

The repair panel 10 is provided in a selection of colors, usually clear amber and red. A repair panel 10 is selected to match the of the lens or housing repaired. As part of a kit the repair panel 10 includes gasket strips 16.

The terms and expressions which are employed are used as terms of description; it is recognized, though, that various modifications are possible.

It is also understood the following claims are intended to cover all of the generic and specific features of the invention herein described; and all statements of the scope of the invention which as a matter of language, might fall therebetween.

Having described certain forms of the invention in some detail, what is claimed is:

1. A kit for repairing a break in a automobile lense or glass bulb housing, including a translucent repair panel, said repair panel including an inner surface, an outer surface, said inner surface flat including ridges protruding outward forming a grid, and a border separating said grid into two parts, and a plurality of gasket strips, said gasket strips including an adhesive surface layers and covered by release sheets.

2. The kit of claim 1 wherein said repair panel is selective colored.

3. The kit of claim 2 wherein said gasket strips are translucent.

4. A kit for repairing a break in a automobile lense or glass bulb housing, including a translucent repair panel, said repair panel including a selection of inner surface portions, including at least including an outer surface, said inner surface flat including ridges protruding outward forming a grid, and a clear surface, and gasket strips, said gasket strips including an adhesive surface layers and covered by release sheets.

5. The kit of claim 4 wherein said repair panel includes a selection of grid patches.

6. A kit for repairing a break in a automobile lense or glass bulb housing, including a translucent repair panel, said repair panel including an inner surface, an outer surface, said inner surface flat including ridges protruding outward forming a grid, and a border separating said grid into two parts, and a plurality of gasket strips, said gasket strips including an adhesive surface layers and covered by release sheets.

7. A kit for repairing a break in an automobile lense or glass bulb housing, including a translucent repair panel, said repair panel including an inner surface, an outer surface, said inner surface flat including ridges protruding outward forming a grid, said repair panel including an adhesive surface layers covered by a release sheet.

8. The method of repairing a break in an automobile lense or glass bulb housing, including the steps of translucent repair panel, said repair panel including an inner surface, an outer surface, said inner surface flat including ridges protruding outward forming a grid, said repair panel including an adhesive surface layers covered by a release sheet, measuring said repair panel over a break in said automobile lense or glass bulb housing, cutting said repair panel to a size to overlap as break, removing said release sheet, and engaging said cut repair panel over as break.
